(19) United States
(12) Patent Application Publication
(10) Pub. No.: US 2005/0064275 A1
(43) Pub. Date: Mar. 24, 2005

(54) Fuel cell gas diffusion layer

(75) Inventors: David R. Mekala, Maplewood, MN (US); David W. Stegink, Mendota Heights, MN (US); Moses M. David, Woodbury, MN (US); Joseph W. Frisk, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/666,626

(22) Filed: Sep. 18, 2003

(51) Int. Cl. H01M 4/94; H01M 4/86; B05D 5/12; B32B 27/28; H01M 4/96

(52) U.S. Cl. 429/42; 429/44; 427/115; 428/421

(57) ABSTRACT

The present invention provides a fuel cell gas diffusion layer comprising a hydrophilic surface layer having a thickness of no more than 1 micron, and, thereunder, a hydrophobic second layer comprising a fluoropolymer having a thickness of at least 5 microns. Additionally, the present invention provides a method of making a fuel cell gas diffusion layer comprising the steps of a) providing a carbon fiber construction; b) coating at least the upper surface of the carbon fiber construction with composition which comprises a fluoropolymer; and c) exposing the upper surface to at least one plasma, such as a silane plasma, so as to generate a hydrophilic surface layer having a thickness of no more than 1 micron. The present invention also provides a method additionally comprising the step of partially covering the upper surface with a mask having windows according to a pattern, such that the hydrophilic surface layer is applied according to the pattern. The present invention also provides a method wherein the carbon fiber construction is provided as a roll good and the step of exposing said upper surface to at least one plasma is performed in continuous roll-to-roll fashion.

### FIELD OF THE INVENTION

This invention relates to gas diffusion layers which may be useful in the manufacture of fuel cells. The gas diffusion layers according to the present invention comprise a thin (sub-micron) hydrophilic surface layer overlying a thicker hydrophobic second layer. Methods of manufacturing gas diffusion layers employing plasma treatment are also provided.

### BACKGROUND OF THE INVENTION

International Patent Application Publication WO 99/05358 purportedly discloses an industrial fabric comprising synthetic yarns or fibers which have been subjected to plasma treatment. The reference asserts that hydrophilic properties are enhanced by using a plasma containing oxygen, air or ammonia. The reference asserts discloses that hydrophobic properties are enhanced by using a plasma containing a silane, a siloxane or a perfluorocarbon.

European Patent No. 0 479 592 B1 purportedly discloses methods of surface treating fluorochemical members, including fluoroplastic resin sheets, for improved adhesion, including treatment with atmospheric glow plasma.

U.S. Pat. No. 5,041,304 purportedly discloses a method for surface treating an article by subjecting the article at its surface to a glow discharge plasma treatment under atmospheric pressure with a gas containing a fluorinated compound, thereby lowering the surface energy of the article, which may impart water repellency to the article surface.

Japan Patent 59-217951 purportedly discloses a fuel cell having an electrode including an electrode substrate treated with an argon plasma, or using nitrogen or another inert gas plasma.

European Patent Application No. EP 1 117 142 A1 purportedly discloses a fuel cell which may include a gas diffusion layer having a water-repelling property. The reference asserts that water-repellency may be imparted by treatment with certain fluorinated silane compounds. The reference asserts that a hydroxyl group may be added to a gas diffusion layer by plasma treatment to serve as a binding site for the fluorinated silane compound.

European Patent No. 0 492 649 B1 purportedly discloses methods of modifying the properties of a textile substrate, which may be a sewing thread, which method may include low temperature plasma treatment with an inert gas or a reactive gas selected from O₂, N₂O, O₃, CO₂, NH₃, SO₂, SiCl₄, CCl₄, CF₃Cl, CF₄, CO, hexamethyldisiloxane and/or H₂.

U.S. Pat. No. 5,041,304 purportedly discloses a low pressure gas plasma process wherein small quantities of water vapor are added to the primary gas constituting the plasma.

U.S. Pat. No. 5,948,166 discloses a process and apparatus for deposition of a carbon-rich coating onto a moving substrate which employs a carbon-rich plasma.

U.S. patent application Ser. No. 09/997,082 discloses a method of making a hydrophobic carbon fiber construction such as a fuel cell gas diffusion layer comprising the steps of: a) immersing a carbon fiber construction in an aqueous dispersion of a highly fluorinated polymer, typically a perfluorinated polymer; b) contacting the dispersion with a counterelectrode; and c) electrophoretically depositing the highly fluorinated polymer onto the carbon fiber construction by applying electric current between the carbon fiber construction and the counterelectrode.

### SUMMARY OF THE INVENTION

Briefly, the present invention provides a fuel cell gas diffusion layer comprising a hydrophilic surface layer having a thickness of no more than 1 micron, and, thereunder, a hydrophobic second layer comprising a fluoropolymer having a thickness of at least 5 microns. The hydrophobic second layer may comprise dispersed particles of carbon and a fluoropolymer. The fuel cell gas diffusion layer may additionally comprise a supporting third layer underlying the second layer, typically a carbon fiber construction coated with a fluoropolymer. Alternately, the hydrophobic second layer may comprise a carbon fiber construction coated with a fluoropolymer. The hydrophilic surface layer may comprise functional groups containing Si or a metal. The hydrophilic surface layer may comprise functional groups additionally containing O, N or S. The present invention also provides a roll good comprising the fuel cell gas diffusion layer described above. The present invention also provides a fuel cell gas diffusion layer as described above wherein the hydrophilic surface layer is present on less than all of the hydrophobic second layer, according to a maskwork pattern.

In another aspect, the present invention provides a method of making a-fuel cell gas diffusion layer comprising the steps of a) providing a carbon fiber construction; b) coating at least the upper surface of the carbon fiber construction with composition which comprises a fluoropolymer; and c) exposing the upper surface to at least one plasma so as to generate a hydrophilic surface layer having a thickness of no more than 1 micron. The plasma may be of species including oxygen, nitrogen, nitrogen dioxide, nitrous oxide, ammonia, sulfur dioxide, silanes, siloxanes and organometallics. Exposure of the upper surface to at least one plasma may be carried out in one step, two steps, or more. Exposure of the upper surface to at least one plasma may comprises exposing said upper surface to a plasma of silane (SiH₄), oxygen, and essentially no other species. Alternately, exposure of the upper surface to at least one plasma may comprise exposing the upper surface to a first plasma and exposing the upper surface to a second plasma. Typically the first plasma is of species including at least one selected from the group consisting of: silanes, siloxanes and organometallics, and the second plasma is of species including at least one selected from the group consisting of: oxygen, nitrogen, nitrogen dioxide, nitrous oxide, ammonia and sulfur dioxide. In addition, the first plasma may additionally include species including at least one selected from the group consisting of: oxygen, nitrogen, nitrogen dioxide, nitrous oxide, ammonia and sulfur dioxide. More typically, the first plasma is of species including a silane, most typically tetramethylsilane, and oxygen, and the second plasma is of species including oxygen. Typically, the step of exposing the upper surface to at least one plasma is carried out at sub-atmospheric pressures. The present invention also provides a method additionally comprising the step of partially covering the upper surface with a mask having windows according to a pattern, such that the hydrophilic surface layer is applied according to the pattern. The present invention also provides a method wherein the carbon fiber construction is provided as a roll good and the step of exposing said upper surface to at least one plasma is performed in continuous roll-to-roll fashion.

What has not been described in the art, and is provided by the present invention, is a largely hydrophobic fuel cell gas diffusion layer comprising a hydrophilic surface layer for strong and uniform binding of fuel cell catalyst.

In this application:

“highly fluorinated” means containing fluorine in an amount of 40 wt % or more, but typically 50 wt % or more, and more typically 60 wt % or more, and includes perfluorinated.

It is an advantage of the present invention to provide a fuel cell gas diffusion layer with hydrophobic properties that can nonetheless bind catalyst strongly and uniformly on its upper surface.

### DETAILED DESCRIPTION

The fuel cell gas diffusion layer according to the present invention may be used in the fabrication of membrane electrode assemblies (MEA's) for use in fuel cells. An MEA is the central element of a proton exchange membrane fuel cell, such as a hydrogen fuel cell. Fuel cells are electrochemical cells which produce usable electricity by the catalyzed combination of a fuel such as hydrogen and an oxidant such as oxygen. Typical MEA's comprise a polymer electrolyte membrane (PEM) (also known as an ion conductive membrane (ICM)), which functions as a solid electrolyte. One face of the PEM is in contact with an anode electrode layer and the opposite face is in contact with a cathode electrode layer. Each electrode layer includes electrochemical catalysts, typically including platinum metal. Gas diffusion layer layers (GDL's) facilitate gas transport to and from the anode and cathode electrode materials and conduct electrical current. The anode and cathode electrode layers may be applied to GDL's in the form of a catalyst ink, and the resulting coated GDL's sandwiched with a PEM to form a five-layer MEA. The five layers of a five-layer MEA are, in order: anode GDL, anode electrode layer, PEM, cathode electrode layer, and cathode GDL. In a typical PEM fuel cell, protons are formed at the anode via hydrogen oxidation and transported across the PEM to the cathode to react with oxygen, causing electrical current to flow in an external circuit connecting the electrodes. The GDL may also be called a fluid transport layer (FTL) or a diffuser/current collector (DCC).

At catalytic sites on each electrode, it is the GDL that provides both a path of electrical conduction and passage for reactant and product fluids such as hydrogen, oxygen and water. Typically, hydrophobic GDL materials are preferred in order to improve transport of product water away from the catalytic sites of the electrode and prevent “flooding.” Applicants have found that the addition of a very thin hydrophilic layer to the upper surface of the GDL can provide an improved uniformity and strength of catalyst binding, resulting in improved fuel cell performance.

Any suitable GDL material may be used in the practice of the present invention. Typically the GDL is comprised of sheet or roll good material comprising carbon fibers. Typically the GDL is a carbon fiber construction selected from woven and non-woven carbon fiber constructions. Carbon fiber constructions which may be useful in the practice of the present invention may include: Toray™ Carbon Paper, SpectraCarb™ Carbon Paper, Zoltek™ Carbon Cloth, AvCarb™ P50 carbon fiber paper, and the like. Typically, the GDL is coated or impregnated with a hydrophobizing treatment such as a dispersion of a fluoropolymer, typically polytetrafluoroethylene (PTFE). In addition, the upper surface may be finished by coating with a dispersion of carbon particles and a fluoropolymer, typically to a thickness of greater than 5 microns, and most typically to a thickness of 10-30 microns.

The GDL according to the present invention comprises a hydrophilic surface layer having a thickness of no more than 1 micron and typically no more than 0.5 micron. The hydrophilic surface layer lays above a hydrophobic second layer comprising a fluoropolymer, having a thickness of at least 5 microns and more typically at least 25 microns. Typically the hydrophobic second layer comprises at least 0.5% by weight of the fluoropolymer, more typically at least 1%, and more typically at least 10%. The hydrophobic second layer may comprise the fluoropolymer-treated carbon fiber construction itself, which may be up to 150 microns thick or more. Alternately, the hydrophobic second layer may comprise a finish layer of dispersed carbon particles and fluoropolymer, typically laying above a supporting third layer, which is typically a fluoropolymer-treated carbon fiber construction. The fluoropolymers recited above are highly fluorinated polymers, and typically perfluorinated polymers, such as polytetrafluoroethylene (PTFE), fluorinated ethylene propylene (FEP), perfluoroalkyl acrylates, hexafluoropropylene copolymers, tetrafluoroethylene/hexafluoropropylene/vinylidene fluoride terpolymers, and the like. Most typically, the fluoropolymers are PTFE.

The hydrophilic surface layer may comprise functional groups containing Si or a metal. More typically the hydrophilic surface layer comprises functional groups containing Si. The hydrophilic surface layer may comprise functional groups additionally containing O, N or S. Typically, the functional groups are derived from ionization products of silanes, including silane (SiH₄), tetramethylsilane and tetraalkyl silanes of mixed or identical alkyl groups, siloxanes and organometallics, including aluminum compounds such as aluminum trichloride, zirconium compounds such as zirconium t-butoxide, titanium compounds such as titanium tetrachloride, copper compounds such as copper hexafluoroacetylacetonate (CuHFAC) and tin compounds such as tetramethyltin. The functional groups may be derived additionally from ionization products of oxygen, nitrogen, nitrogen dioxide, nitrous oxide, ammonia and sulfur dioxide.

The GDL according to the present invention may be provided in sheets, as a roll good, or in any suitable form. The GDL according to the present invention may be patterned, such that the hydrophilic surface layer is present on less than all of the hydrophobic second layer, according to a maskwork pattern. Any suitable pattern may be used.

The GDL according to the present invention may be made by any suitable means. Typically, the GDL according to the present invention is made by a method employing plasma treatment, such as the method described following.

The present invention provides a method of making a fuel cell gas diffusion layer comprising the steps of a) providing a carbon fiber construction; b) coating at least the upper surface of the carbon fiber construction with a composition which comprises a fluoropolymer; and c) exposing the upper surface to at least one plasma so as to generate a hydrophilic surface layer having a thickness of no more than 1 micron. Any suitable carbon fiber construction may be used in the practice of the present invention. Exemplary carbon fiber constructions are described above. Typically, the carbon fiber construction has an average thickness of between 30 and 300 microns, more typically between 100 and 250 microns, and most typically between 150 and 200 microns.

The carbon fiber construction may be coated by any suitable means, including both hand and machine methods, including dipping, spraying, brushing, notch bar coating, fluid bearing die coating, wire-wound rod coating, fluid bearing coating, slot-fed knife coating or three-roll coating. Alternately, electrophoretic deposition may be used, as described in U.S. patent application Ser. No. 09/997,082, incorporated herein by reference. Coating may be achieved in one application or in multiple applications.

Any suitable composition which comprises a fluoropolymer may be used. The composition typically comprises a carrier which may be any suitable carrier, which may include organic or inorganic solvents, and which is typically aqueous. The fluoropolymer is a highly fluorinated polymer and typically a perfluorinated polymer, such as polytetrafluoroethylene (PTFE), fluorinated ethylene propylene (FEP), perfluoroalkyl acrylates, hexafluoropropylene copolymers, tetrafluoroethylene/hexafluoropropylene/vinylidene fluoride terpolymers, and the like. Most typically, the fluoropolymer is PTFE. Suitable compositions include Teflon® PTFE 30B colloidal suspension (DuPont Fluoroproducts, Wilmington, Del.), which may be diluted to 1% with deionized water.

Most typically, the carbon fiber construction is coated throughout by dipping in a dispersion of PTFE in water, and then a finish coat is applied to the upper surface by notch bar coating, the finish coat comprising carbon particles a dispersion of PTFE and carbon particles in water.

Any suitable plasma treatment apparatus may be used. Typically, the apparatus includes a housing capable of containing the carbon fiber construction for treatment and capable of maintaining sub-atmospheric pressures, apparatus for evacuation of the housing and provision of plasma gasses at suitable pressures, and electrodes for plasma generation with an appropriate power source. A suitable apparatus for plasma treatment of roll goods is disclosed in U.S. Pat. No. 5,948,166, incorporated herein by reference. Typically, the step of exposing the upper surface to at least one plasma is carried out at sub-atmospheric pressures, typically 10-1,000 mtorr, more typically 50-500 mtorr, most typically about 150 mtorr. Typically, the step of exposing the upper surface to at least one plasma is carried out at room temperature. Typically, the step of exposing the upper surface to at least one plasma is carried out with application of 100-500 Watts of power, more typically 200-400 Watts, and most typically about 300 Watts.

The plasma may be of species including oxygen, nitrogen, nitrogen dioxide, nitrous oxide, ammonia, sulfur dioxide, silanes, including silane (SiH₄), tetramethylsilane and tetraalkyl silanes of mixed or identical alkyl groups, siloxanes and organometallics, including aluminum compounds such as aluminum trichloride, zirconium compounds such as zirconium t-butoxide, titanium compounds such as titanium tetrachloride, copper compounds such as copper hexafluoroacetylacetonate (CuHFAC) and tin compounds such as tetramethyltin. Inert gasses may additionally be present during plasma treatment. Exposure of the upper surface to at least one plasma may be carried out in one step, two steps, or more.

In one embodiment including a single plasma treatment step, the upper surface is exposed to a plasma of silane (SiH₄), oxygen, and essentially no other species. Power and duration of exposure are adjusted to provide a hydrophilic surface layer having a thickness of no more than 1 micron.

In a further embodiment, the upper surface is exposed to a first plasma and then a second plasma. Typically the first plasma is of species including at least one selected from the group consisting of: silanes, siloxanes and organometallics, and the second plasma is of species including at least one selected from the group consisting of: oxygen, nitrogen, nitrogen dioxide, nitrous oxide, ammonia and sulfur dioxide. In addition, the first plasma may additionally include species including at least one selected from the group consisting of: oxygen, nitrogen, nitrogen dioxide, nitrous oxide, ammonia and sulfur dioxide. More typically, the first plasma is of species including a silane, most typically tetramethylsilane, and oxygen, and the second plasma is of species including oxygen. Power and duration of exposure are adjusted to provide a hydrophilic surface layer having a thickness of no more than 1 micron.

The present invention also provides a method additionally comprising the step of partially covering the upper surface with a mask having windows according to a pattern, such that the hydrophilic surface layer is applied according to the pattern. The mask may be made of any suitable material, including metals, such as aluminum, and polymers, such as polyester, and the like. Subsequently, the plasma treated GDL is coated with a catalyst-containing composition or ink. Unbound catalyst may then be removed, e.g., by washing, and recovered. This method can result in more efficient use of costly catalyst by eliminating the unnecessary use of catalyst on non-active areas of the GDL.

The carbon fiber construction may alternately be provided as a roll good and the step of exposing said upper surface to at least one plasma performed in continuous roll-to-roll fashion. A suitable apparatus for plasma treatment of roll goods is disclosed in U.S. Pat. No. 5,948,166, incorporated herein by reference. The apparatus described therein may be adapted by provision of a wider drum (17 cm) suitable for GDL production.

Alternately, masking a roll good methods may be used together. IN one embodiment, a roll-length mask is provided and This invention is useful in the manufacture of fuel cells.

Objects and advantages of this invention are further illustrated by the following examples, but the particular materials and amounts thereof recited in these examples, as well as other conditions and details, should not be construed to unduly limit this invention.

### EXAMPLES

Unless otherwise noted, all reagents were obtained or are available from Aldrich Chemical Co., Milwaukee, Wis., or may be synthesized by known methods.

Plasma Reactor

A commercial parallel-plate capacitively coupled reactive ion etcher (commercially available as Model 2480 from PlasmaTherm of St. Petersburg, Fla.) was used for plasma treatment of the GDL samples. The treatments occurred while the sample was in an ion sheath that was proximate an electrode. The reactor included a grounded chamber electrode containing a powered electrode. The chamber was cylindrical in shape with an internal diameter of 762 mm (30 inches) and height of 150 mm (6 inches). A circular electrode having a diameter of 686 mm (27 inches) was mounted inside the chamber and attached to a matching network and a 3 kW RF power supply that was operated at a frequency of 13.56 MHz. The chamber was vacuum pumped with a Roots blower backed by a mechanical pump. Unless otherwise stated, the base pressure in the chamber was 0.67 Pa (5 mTorr). Process gases were metered into the chamber either through mass flow controllers or a needle valve. All the plasma treatments were done with the sample located on the powered electrode of the plasma reactor. Pressure in the chamber was controlled independently with a throttle valve and controller before the pump.

### Example 1

### Three Step Process

In this example, the plasma treatment of the GDL was done in three separate steps. In the first step, the membrane is primed with an oxygen plasma to enable good adhesion of the silicon containing layer deposited in the second step from a mixture of tetramethylsilane and oxygen. A final, third step was used to convert the hydrophobic methyl groups left behind from the deposition from tetramethylsilane into oxide or hydroxyl groups that render the surface hydophilic.

GDL material (Toray™ Carbon Paper) was clamped in the chamber of the aluminum reactor and the apparatus was sealed. The chamber was evacuated to a pressure of 150 mTorr, oxygen was introduced at a flow rate of 500 sccm (standard cubic centimeters per minute) and a plasma was generated at a power of 300 Watts. The operation was carried out at room temperature. The duration of plasma generation in the first step was 10 seconds. In the second step, oxygen and tetramethyl silane were introduced at flow rates of 500 sccm 50 sccm respectively. The duration of plasma generation in the second step was 20 seconds. In a third step, oxygen gas was again introduced at a flow rate of 500 sccm. The duration of plasma generation in the third step was 30 seconds.

### Example 2

### One Step Process

Hydrophilic treatment was accomplished in a single step by choosing a precursor, silane (SiH₄), that does not contain methyl groups.

The same apparatus was used as described above in Example 1.

GDL material (Zoltek™ Carbon Cloth) was clamped in the chamber of the aluminum reactor and the apparatus was sealed. The chamber was evacuated to a pressure of 150 mTorr. A premixed gas containing 2% silane in argon was introduced at a flow rate of 500 sccm along with oxygen, also at a flow rate of 500 sccm. A plasma was generated at a power of 300 Watts. The operation was carried out at room temperature. The duration of plasma generation in the first step was 30 seconds.

### Example 3

### Patterned Surface Treatment

GDL material (AvCarb™ P50 carbon fiber paper) was clamped in the chamber of the aluminum reactor and covered with a ¼-inch thick aluminum plate containing square cutouts. The apparatus was sealed. The chamber was evacuated to a pressure of 150 mTorr. A premixed gas containing 2% silane in argon was introduced at a flow rate of 500 sccm along with oxygen, also at a flow rate of 500 sccm. A plasma was generated at a power of 300 Watts. The operation was carried out at room temperature. The duration of plasma generation in the first step was 30 seconds.

The resulting GDL had a hydrophilic coating only in regions corresponding to the square cutouts.

### Example 4

### Continuous Surface Treatment with Patterned Surface Treatment

The apparatus for continuous surface treatment described in U.S. Pat. No. 5,948,166 was fitted with a larger treatment drum, having a width of 16.5 cm (6.5 inches), and used in the present Example.

A roll of GDL material (AvCarb™ P50 carbon fiber paper) was mounted in the apparatus. A polyester mask having windows cut therein was wrapped around the drum electrode. The apparatus was sealed. The chamber was evacuated to a pressure of 150 mTorr. A premixed gas containing 2% silane in oxygen was introduced at a flow rate of 500 sccm along with oxygen, also at a flow rate of 500 sccm. A plasma was generated at a power of 500 Watts. The operation was carried out at room temperature. The web speed was maintained at 10 feet/min, corresponding to a treatment time of about 30 seconds.

The hydrophilicity of the treated GDL was confirmed by applying water from a dropper along the treated surface. The water wet out nicely and formed a trace along the treated surface and beaded up without wetting on the untreated surface.

### Example 5

MEA's were made from GDL's treated as described in Example 4. The MEA's demonstrated improved performance over MEA's made from comparative GDL's.

Various modifications and alterations of this invention will become apparent to those skilled in the art without departing from the scope and principles of this invention, and it should be understood that this invention is not to be unduly limited to the illustrative embodiments set forth hereinabove.

1. A fuel cell gas diffusion layer comprising a hydrophilic surface layer having a thickness of no more than 1 micron, and, thereunder, a hydrophobic second layer comprising a fluoropolymer having a thickness of at least 5 microns.

2. The fuel cell gas diffusion layer according to claim 1 wherein said hydrophobic second layer comprises dispersed particles of carbon and a fluoropolymer.

3. The fuel cell gas diffusion layer according to claim 1 wherein said hydrophobic second layer comprises a carbon fiber construction coated with a fluoropolymer.

4. The fuel cell gas diffusion layer according to claim 1 additionally comprising a supporting third layer underlying said second layer.

5. The fuel cell gas diffusion layer according to claim 4 wherein said supporting third layer comprises a carbon fiber construction coated with a fluoropolymer.

6. The fuel cell gas diffusion layer according to claim 2 additionally comprising a supporting third layer underlying said second layer.

7. The fuel cell gas diffusion layer according to claim 6 wherein said supporting third layer comprises a carbon fiber construction coated with a fluoropolymer.

8. The fuel cell gas diffusion layer according to claim 1 wherein said hydrophilic surface layer comprises functional groups containing Si or a metal.

9. The fuel cell gas diffusion layer according to claim 1 wherein said hydrophilic surface layer comprises functional groups containing Si.

10. The fuel cell gas diffusion layer according to claim 1 wherein said hydrophilic surface layer comprises functional groups containing Si and O.

11. A roll good comprising the fuel cell gas diffusion layer according to claim 1.

12. The fuel cell gas diffusion layer according to claim 1 wherein said hydrophilic surface layer is present on less than all of said hydrophobic second layer, according to a pattern.

13. A method of making a fuel cell gas diffusion layer comprising the steps:
a) providing a carbon fiber construction having an upper surface;
b) coating at least said upper surface of said carbon fiber construction with composition which comprises a fluoropolymer;
c) exposing said upper surface to at least one plasma so as to generate a hydrophilic surface layer having a thickness of no more than 1 micron.

14. The method according to claim 13 wherein said step c) comprises steps d) and e):
d) exposing said upper surface to a first plasma; and
e) exposing said upper surface to a second plasma.

15. The method according to claim 13 wherein said plasma is of species including at least one selected from the group consisting of: oxygen, nitrogen, nitrogen dioxide, nitrous oxide, ammonia and sulfur dioxide.

16. The method according to claim 15 wherein said plasma is additionally of species including at least one selected from the group consisting of: silanes, siloxanes and organometallics.

17. The method according to claim 14 wherein said first plasma is of species including at least one selected from the group consisting of: silanes, siloxanes and organometallics, and wherein said second plasma is of species including at least one selected from the group consisting of: oxygen, nitrogen, nitrogen dioxide, nitrous oxide, ammonia and sulfur dioxide.

18. The method according to claim 14 wherein said first plasma is additionally of species including at least one selected from the group consisting of: oxygen, nitrogen, nitrogen dioxide, nitrous oxide, ammonia and sulfur dioxide.

19. The method according to claim 14 wherein said first plasma is of species including a silane and oxygen and wherein said second plasma is of species including oxygen.

20. The method according to claim 19 where said silane is tetramethylsilane.

21. The method according to claim 13, additionally comprising the step of:
f) partially covering said upper surface with a mask having windows according to a pattern such that said hydrophilic surface layer having a thickness of no more than 1 micron is applied according to said pattern.

22. The method according to claim 13 wherein said carbon fiber construction is provided as a roll good and said step of exposing said upper surface to at least one plasma is performed in continuous roll-to-roll fashion.

23. The method according to claim 13 wherein said step c) of exposing said upper surface to at least one plasma is carried out at sub-atmospheric pressures.

24. The method according to claim 13 wherein said step c) comprises exposing said upper surface to a plasma of silane (SiH₄), oxygen, and essentially no other species.

25. The method according to claim 24, additionally comprising the step of:
f) partially covering said upper surface with a mask having windows according to a pattern such that said hydrophilic surface layer having a thickness of no more than 1 micron is applied according to said pattern.

26. The method according to claim 24 wherein said carbon fiber construction is provided as a roll good and said step of exposing said upper surface to at least one plasma is performed in continuous roll-to-roll fashion.

27. The method according to claim 24 wherein said step c) of exposing said upper surface to at least one plasma is carried out at sub-atmospheric pressures.

28. The method according to claim 13 additionally comprising the step of:
g) exposing said upper surface to at least one priming plasma of species including at least one selected from the group consisting of: oxygen, nitrogen, nitrogen dioxide, nitrous oxide, ammonia and sulfur dioxide prior to step c).

29. The method according to claim 13 additionally comprising the step of:
g) exposing said upper surface to at least one priming plasma of species including at least one selected from the group consisting of: oxygen, nitrogen, nitrogen dioxide, nitrous oxide, ammonia and sulfur dioxide prior to step d).

30. A fuel cell electrode comprising the fuel cell gas diffusion layer according to claim 1 and a layer of fuel cell electrode catalyst in contact with said hydrophilic surface layer.
